(19) United States
(12) Patent Application Publication
(10) Pub. No.: US 2014/0219148 A1
(43) Pub. Date: Aug. 7, 2014

(54) Method and Apparatus for Waking Up a Device

(71) Applicant: Huawei Device Co., Ltd., Shenzhen (CN)

(72) Inventors: Xuewen Zhao, Xi'an (CN); Haifeng Lin, Shenzhen (CN)

(21) Appl. No.: 14/144,237

(22) Filed: Dec. 30, 2013

Related U.S. Application Data
(63) Continuation of application No. PCT/CN2013/084900, filed on Oct. 9, 2013.

(30) Foreign Application Priority Data
Feb. 4, 2013 (CN) 201310042704.0

(51) Int. Cl. H04W 52/02

(52) U.S. Cl. CPC H04W 52/0229
USPC 370/311

(57) ABSTRACT

A method and an apparatus for waking up a device are disclosed by embodiments of the present invention. In one embodiment, a method includes detecting, by a first device, whether a second device transmits a radio signal, when a timing interval of a timer is equal to a preset threshold, where the first device is a device woken up by the second device, transmitting, by the first device, a first message to the second device when the radio signal is detected, causing the second device to switch to a station (STA) mode after receiving the first message, where the first message is used to notify the second device that the first device is woken up successfully, and switching, by the first device, to an access point (AP) mode, causing the second device to implement wireless fidelity (Wi-Fi) access through the first device.

This application is a continuation of International Application No. PCT/CN2013/084900, filed on Oct. 9, 2013, which claims priority to Chinese Patent Application No. 201310042704.0, filed on Feb. 4, 2013, both of which are hereby incorporated by reference in their entireties.

### TECHNICAL FIELD

The present invention relates to the field of communications, and in particular, to a method and an apparatus for waking up a device.

### BACKGROUND

Generally With the development of mobile communications technologies, a wireless fidelity (Wi-Fi) technology has become a wireless network transmission technology used most widely currently. A user only needs to use a device supporting Wi-Fi in a Wi-Fi coverage area to connect to a Wi-Fi network, so that the user can quickly browse web pages, send and receive emails, and so on.

Currently, a Wi-Fi access point (AP) device needs to keep working for a long time so that it can be accessed by a Wi-Fi station (STA) at any time and used by a user conveniently. However, rarely can Wi-Fi STAs access a normal Wi-Fi AP device for 24 hours every day. The Wi-Fi AP device is in an idle state in a long period of time, which causes a waste of network resources. Furthermore, if a portable Wi-Fi AP device powered by batteries is unable to enter a standby state, the Wi-Fi AP device continues to be powered by the batteries when it is not accessed by a Wi-Fi STA. Consequently, the service time of the Wi-Fi AP device is shortened, and the service life of the batteries is also affected.

A solution in the prior art is as follows. When the Wi-Fi AP device is not accessed by a Wi-Fi STA, the Wi-Fi AP device automatically enters the standby state after a period of time. If the user needs to continue to use Wi-Fi, the user needs to wake up the Wi-Fi AP device by pressing a key or using other control manners, so that the Wi-Fi AP device reenters an enabled state.

In the prior art, after the Wi-Fi AP device enters the standby state, the user needs to wake up the Wi-Fi AP device by pressing a key or using other control manners before the user can continue to use Wi-Fi. Therefore, user experience is poor. Therefore, how to effectively wake up the Wi-Fi AP device has become an important topic in this technical field.

### SUMMARY OF THE INVENTION

Embodiments of the present invention provide a method and an apparatus for waking up a device, which improve user experience in a device wake-up process.

According to a first aspect of the present invention, a method for waking up a device is provided and includes detecting, by a first device when a timing interval of a timer is equal to a preset threshold, whether a second device transmits a radio signal, where the first device is a device woken up by the second device, transmitting, by the first device when the radio signal is detected, a first message to the second device, causing the second device to switch to a STA mode after receiving the first message, where the first message is used to notify the second device that the first device is woken up successfully, switching, by the first device, to an AP mode, causing the second device to implement wireless fidelity Wi-Fi access through the first device, and disabling, by the first device, the Wi-Fi and restarting the timer when the radio signal is not detected.

With reference to the first aspect, in a possible implementation manner, the transmitting, by the first device when the radio signal is detected, a first message to the second device, includes switching, by the first device, to the STA mode when the radio signal is detected, implementing, by the first device, the Wi-Fi access through the second device, and transmitting, by the first device, the first message to the second device, where the first message carries a switching time to instruct the second device to switch to the STA mode within the switching time.

With reference to the first aspect or the foregoing possible implementation manner, in another possible implementation manner, before the detecting, by a first device, whether a second device transmits a radio signal, and when a timing interval of a timer is equal to a preset threshold, the method further includes storing, by the first device, wake-up information of the second device, where the wake-up information includes at least a Wi-Fi network identifier, and the detecting whether the second device transmits the radio signal specifically includes detecting, by the first device according to the wake-up information, whether the second device transmits the radio signal.

According to a second aspect of the present invention, a method for waking up a device is provided and includes entering, by a first device, an AP mode when a timing interval of a timer is equal to a preset threshold, where the first device is a device woken up by a second device, detecting, by the first device, whether a wake-up password transmitted by the second device is received, transmitting, by the first device, a first message to the second device when the wake-up password is detected, causing the second device to switch to a STA mode after receiving the first message, and the second device implements Wi-Fi access through the first device, where the first message is used to notify the second device that the first device is woken up successfully, and disabling, by the first device, the Wi-Fi and restarting the timer when the wake-up password is not detected.

With reference to the second aspect, in a possible implementation manner, the transmitting, by the first device, a first message to the second device when the wake-up password is detected, includes, detecting, by the first device, whether the second device corresponding to the wake-up password exists in a pre-stored list of devices that can wake up the first device, when the wake-up password is detected, and performing the transmitting of the first message to the second device when the second device corresponding to the wake-up password exists in the pre-stored list of devices that can wake up the first device.

According to a third aspect of the present invention, a method for waking up a device is provided and includes receiving, by a first device, a wake-up password transmitted by a second device by using a communications technology, where the first device is a device woken up by the second device, transmitting, by the first device, a first message to the second device, causing the second device to switch to a STA mode after receiving the first message, where the first message is used to notify the second device that the first device is woken up successfully, and switching, by the first device, to an AP mode, causing the second device to implement Wi-Fi access through the first device.

With reference to the third aspect, in a possible implementation manner, after the receiving, by the first device, a wake-up password transmitted by a second device by using a communications technology, the method further includes detecting whether the second device corresponding to the wake-up password exists in a pre-stored list of devices that can wake up the first device.

With reference to the third aspect or the foregoing possible implementation manner, in another possible implementation manner, the transmitting, by the first device, a first message to the second device, includes transmitting, by the first device, the first message to the second device when the second device corresponding to the wake-up password exists in the pre-stored list of devices that can wake up the first device.

According to a fourth aspect of the present invention, an apparatus for waking up a device is provided and includes a detecting unit configured to detect whether a second device transmits a radio signal, when a timing interval of a timer is equal to a preset threshold, where a first device is a device woken up by the second device, a transmitting unit configured to transmit a first message to the second device when the detecting unit detects the radio signal, causing the second device to switch to a STA mode after receiving the first message, where the first message is used to notify the second device that the first device is woken up successfully, a switching unit configured to switch to an AP mode, causing the second device to implement Wi-Fi access through the first device, and a processing unit configured to disable the Wi-Fi when the detecting unit does not detect the radio signal and restart the timer.

With reference to the fourth aspect, in a possible implementation manner, the transmitting unit includes a switching module configured to switch to the STA mode when the detecting unit detects the radio signal, an accessing module configured to implement the Wi-Fi access through the second device, and a transmitting module configured to transmit the first message to the second device, where the first message carries a switching time to instruct the second device to switch to the STA mode within the switching time.

With reference to the fourth aspect or the foregoing possible implementation manner, in another possible implementation manner, the apparatus further includes a storing unit configured to store wake-up information of the second device before the detecting unit detects whether the second device transmits the radio signal when the timing interval of the timer is equal to the preset threshold, where the wake-up information includes at least a Wi-Fi network identifier, where the detecting unit includes a detecting module configured to detect, whether the second device transmits the radio signal, according to the wake-up information stored by the storing unit.

According to a fifth aspect of the present invention, an apparatus for waking up a device is provided and includes an entering unit configured to enter an AP mode when a timing interval of a timer is equal to a preset threshold, where a first device is a device woken up by a second device, a detecting unit configured to detect whether a wake-up password transmitted by the second device is received, a transmitting unit configured to transmit a first message to the second device when the detecting unit detects the wake-up password, causing the second device to switch to a STA mode after receiving the first message, and the second device implements Wi-Fi access through the first device, where the first message is used to notify the second device that the first device is woken up successfully, and a processing unit configured to disable the Wi-Fi when the detecting unit does not detect the wake-up password and restart the timer.

With reference to the fifth aspect, in a possible implementation manner, the transmitting unit includes a detecting module configured to detect whether the second device corresponding to the wake-up password exists in a pre-stored list of devices that can wake up the first device when the detecting unit detects the wake-up password, and a transmitting module configured to transmit the first message to the second device when the detecting module detects that the second device corresponding to the wake-up password exists in the pre-stored list of devices that can wake up the first device.

According to a sixth aspect of the present invention, an apparatus for waking up a device is provided and includes a receiving unit configured to receive a wake-up password transmitted by a second device by using a communications technology, where a first device is a device woken up by the second device, a transmitting unit configured to transmit a first message to the second device, causing the second device to switch to a STA mode after receiving the first message, where the first message is used to notify the second device that the first device is woken up successfully, and a switching unit configured to switch to an AP mode, causing the second device to implement Wi-Fi access through the first device.

With reference to the sixth aspect, in a possible implementation manner, the apparatus further includes a detecting unit configured to detect whether the second device corresponding to the wake-up password exists in a pre-stored list of devices that can wake up the first device, after the receiving unit receives the wake-up password transmitted by the second device by using the communications technology.

With reference to the sixth aspect or the foregoing possible implementation manner, in another possible implementation manner, the transmitting unit includes a transmitting module configured to transmit the first message to the second device when the detecting unit detects that the second device corresponding to the wake-up password exists in the pre-stored list of devices that can wake up the first device.

In the method and apparatus for waking up a device according to the embodiments of the present invention, when a timing interval of a timer is equal to a preset threshold and when a first device detects a radio signal transmitted by a second device, the first device transmits a first message to the second device, where the first message is used to instruct the second device to switch to a STA mode. In this case, the first device is woken up, that is, the first device switches to an AP mode, causing the second device to implement Wi-Fi access through the first device. The first device switches to the AP mode when the radio signal of the second device is detected, which improves user experience in a device wake-up process. In addition, the first device enters a standby mode when the radio signal of the second device is not detected, which effectively reduces power consumption of the first device and prolongs the standby time and service life of batteries.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for waking up a device according to an embodiment of the present invention;

FIG. 2 is a schematic flowchart of another method for waking up a device according to an embodiment of the present invention;

FIG. 3 is a schematic flowchart of another method for waking up a device according to an embodiment of the present invention;

FIG. 4 is a schematic flowchart of another method for waking up a device according to an embodiment of the present invention;

FIG. 5 is a schematic structural diagram of an apparatus for waking up a device according to an embodiment of the present invention;

FIG. 6 is a schematic structural diagram of composition of another apparatus for waking up a device according to an embodiment of the present invention;

FIG. 7 is a schematic structural diagram of composition of another apparatus for waking up a device according to an embodiment of the present invention;

FIG. 8 is a schematic structural diagram of composition of another apparatus for waking up a device according to an embodiment of the present invention;

FIG. 9 is a schematic structural diagram of composition of another apparatus for waking up a device according to an embodiment of the present invention;

FIG. 10 is a schematic structural diagram of composition of another apparatus for waking up a device according to an embodiment of the present invention;

FIG. 11 is a schematic structural diagram of composition of another apparatus for waking up a device according to an embodiment of the present invention;

FIG. 12 is a schematic structural diagram of composition of another apparatus for waking up a device according to an embodiment of the present invention; and

FIG. 13 is a schematic structural diagram of composition of another apparatus for waking up a device according to an embodiment of the present invention.

### DETAILED DESCRIPTION OF ILLUSTRATIVE EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

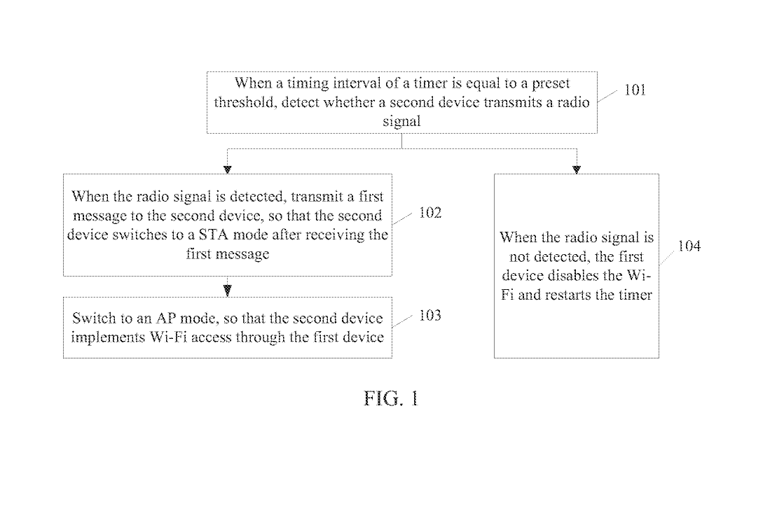

An embodiment of the present invention provides a method for waking up a device. As shown in FIG. 1, the method may include the following steps.

101. When a timing interval of a timer is equal to a preset threshold, a first device detects whether a second device transmits a radio signal. The first device is a device that may be woken up by the second device. Specifically, when no device accesses the first device within a preset time, the first device disables Wi-Fi and enters a standby mode. In this case, the first device may start a timer, and detect, when the timing interval of the timer is equal to the preset threshold, whether the second device transmits a radio signal. When the second device needs to implement Wi-Fi access through the first device, the second device may switch to an AP mode. In this case, the second device may transmit a radio signal.

102. When the radio signal is detected, the first device transmits a first message to the second device, so that the second device switches to a STA mode after receiving the first message. When the first device detects the radio signal of the second device, the first device learns that the second device needs to implement Wi-Fi access through the first device. In this case, the first device transmits the first message to the second device, where the first message is used to notify the second device that the first device is woken up successfully. When the second device receives the first message, the second device switches to the STA mode, and further prepares for Wi-Fi access.

103. The first device switches to the AP mode, so that the second device implements Wi-Fi access through the first device. The first device may also switch to the AP mode after transmitting the first message to the second device, so that the second device implements Wi-Fi access through the first device.

104. When the radio signal is not detected, the first device disables the Wi-Fi and restarts the timer. When the first device does not detect the radio signal of the second device, the first device disables the Wi-Fi, reenters the standby mode, and restarts the timer.

In the method for waking up a device according to the embodiment of the present invention, when a timing interval of a timer is equal to a preset threshold and when a first device detects a radio signal transmitted by a second device, the first device transmits a first message to the second device, where the first message is used to instruct the second device to switch to a STA mode. In this case, the first device is woken up, that is, the first device switches to an AP mode, causing the second device to implement Wi-Fi access through the first device. The first device switches to the AP mode when the radio signal of the second device is detected, which improves user experience in a device wake-up process. In addition, the first device enters a standby mode when the radio signal of the second device is not detected, which effectively reduces power consumption of the first device and prolongs the standby time and service life of batteries.

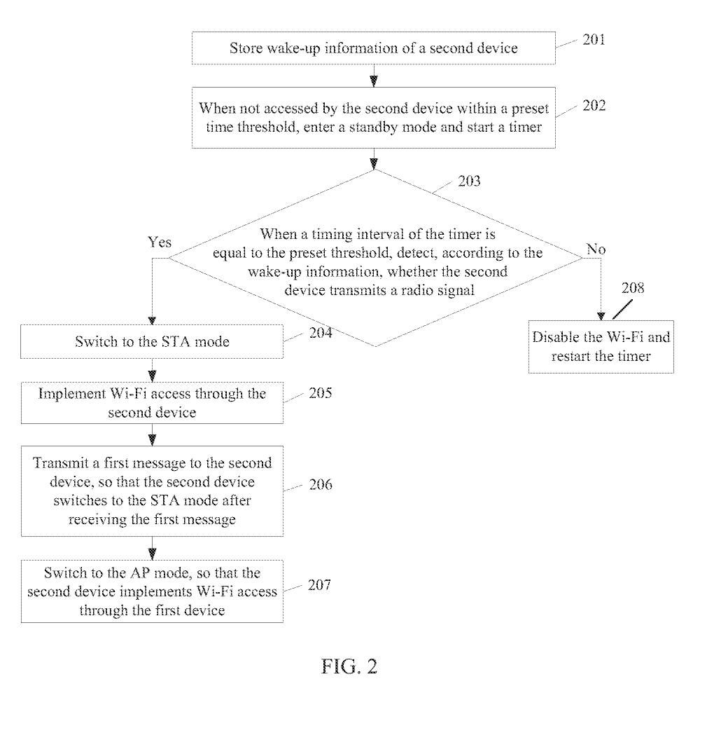

An embodiment of the present invention provides a method for waking up a device, where the method is applicable to a first device, where the first device may be a device such as a smartphone that supports both a Wi-Fi AP mode and a Wi-Fi STA mode. As shown in FIG. 2, the method may include the following steps.

201. A first device stores wake-up information of a second device. The first device may pre-store wake-up information of the second device in the first device, so that the information is used when wake-up is implemented subsequently. The method for pre-storing wake-up information of the second device may be as follows. When the second device implements Wi-Fi access through the first device, the second device registers the wake-up information with the first device, or the wake-up information of the second device may also be directly configured in the first device. The embodiment of the present invention does not limit the manner of storing the wake-up information.

Optionally, the first device may locally maintain a list of devices that can wake up the first device, where the devices corresponding to the wake-up information stored in the list of devices that can wake up the first device may all wake up the first device. Note the wake-up information in the embodiment of the present invention includes a Wi-Fi network identifier of the second device, and may also include a ciphering mode and/or password.

202. When not accessed by the second device within a preset time threshold, the first device enters a standby mode and starts a timer. Specifically, to avoid a waste of network resources because the first device keeps in an enabled state when it is not accessed by a Wi-Fi STA, if no second device accesses the first device within the preset time threshold, the first device may disable the Wi-Fi function and enter a standby state and start a timer T₀ at the same time.

203. When a timing interval of the timer is equal to the preset threshold, the first device detects, according to the wake-up information, whether the second device transmits a radio signal; and when the radio signal is detected, performs the following steps 204-207; or when the radio signal is not detected, performs the following step 208.

When the timer T₀ is equal to the preset threshold, the first device may detect, according to the wake-up information, whether the second device transmits the radio signal. Specifically, when the first device scans whether a device transmits a radio signal, it is possible that the first device detects multiple radio signals; in this case, the first device may determine, according to the pre-stored wake-up information, whether the device corresponding to each radio signal may wake up the first device. When the second device needs to wake up the first device, the second device switches to the AP mode by using the wake-up information that is pre-registered with the first device and transmits a radio signal. In this case, when the timer T₀ is equal to the preset threshold, the first device may detect the radio signal. To ensure that the first device may implement Wi-Fi access through the second device, the second device is in the AP mode for a duration of T₂=T₀+2×T₁, where T₁ is the duration of a detection and access attempt for the first device.

Optionally, when the first device maintains a list of devices that can wake up the first device, the first device may scan whether the second device that is in the list of devices that can wake up the first device transmits a radio signal.

204. The first device switches to the STA mode. The first device switches to the STA mode to prepare for communication with the second device. Note the first device may switch to the STA mode when the timing interval of the timer is equal to the preset threshold, or may switch to the STA mode when detecting a radio signal. The time at which the first device switches to the STA mode is not limited by the embodiment of the present invention.

205. The first device implements Wi-Fi access through the second device. When the first device detects the radio signal, the first device may switch to the STA mode. In this case, the first device may implement Wi-Fi access through the second device to communicate with the second device.

206. The first device transmits a first message to the second device, so that the second device switches to the STA mode after receiving the first message. When the first device implements Wi-Fi access through the second device, the first device may transmit the first message to the second device, where the first message is used to notify the second device that the first device is woken up successfully. The first message may further carry a switching time to notify the second device that the first device is woken up after the switching time, that is, the first device switches to the AP mode after the switching time. The second device may switch to the STA mode within the switching time after receiving the first message to implement Wi-Fi access through the first device.

Optionally, the switching time may also be preset in the second device, that is, after the second device receives the first message, the second device may learn, according to the preset switching time, that the first device is woken up successfully after the second device receives the first message and waits for the switching time.

207. The first device switches to the AP mode, so that the second device implements Wi-Fi access through the first device. The first device may switch to the AP mode after transmitting the first message to the second device, so that the second device implements Wi-Fi access through the first device.

208. The first device disables the Wi-Fi and restarts the timer. When the first device does not detect the radio signal of the second device, the first device disables the Wi-Fi and restarts the timer.

In the method for waking up a device according to the embodiment of the present invention, when a timing interval of a timer is equal to a preset threshold and when a first device detects a radio signal transmitted by a second device, the first device transmits a first message to the second device, where the first message is used to instruct the second device to switch to a STA mode. In this case, the first device is woken up, that is, the first device switches to an AP mode, so that the second device may implement Wi-Fi access through the first device. The first device switches to the AP mode when the radio signal of the second device is detected, which improves user experience in a device wake-up process. In addition, the first device enters a standby mode when the radio signal of the second device is not detected, which effectively reduces power consumption of the first device and prolongs the standby time and service life of batteries.

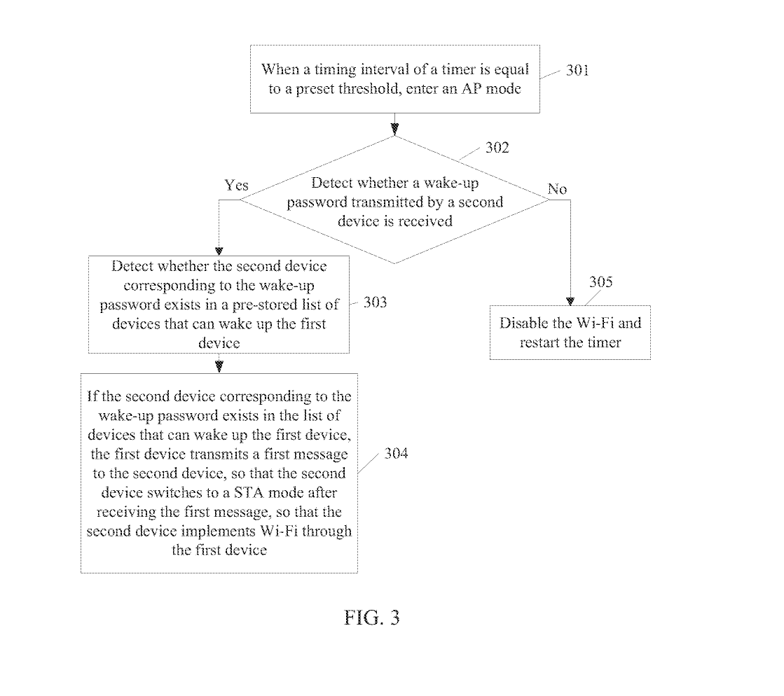

An embodiment of the present invention provides a method for waking up a device, where the method is applicable to a first device, where the first device may be a device that supports a Wi-Fi AP mode. As shown in FIG. 3, the method includes the following steps.

301. When a timing interval of a timer is equal to a preset threshold, a first device enters an AP mode. The first device may enter a standby mode when no second device accesses the first device within a period of time, start a timer T₀ at the same time, and when the timer T₀ is equal to the preset threshold, switch to a working state, namely, enter the AP mode.

302. The first device detects whether a wake-up password transmitted by a second device is received; and when the wake-up password is detected, perform the following steps 303 and 304; or when the wake-up password is not detected, perform the following step 305.

When the second device needs to implement Wi-Fi access through the first device, the second device may switch to the AP mode. In this case, the second device broadcasts a wake-up password at a time interval. The first device may detect whether the wake-up password transmitted by the second device is received. To ensure that the first device can receive the wake-up password transmitted by the second device, the time interval T₂ at which the second device broadcasts the wake-up password needs to be less than T₁, where T₁ is the time when the first device attempts to receive the wake-up password.

Optionally, the second device may also directly transmit the wake-up password to the first device. Note the format and content of the wake-up password are pre-agreed by the first device and second device. In addition, the wake-up password broadcast by the second device may be implemented by adding Wi-Fi signaling, such as in a signaling format similar to a beacon frame, or by extending existing signaling, for example, by adding a vendor (a customized field) to probe request (probe req) and probe response (probe rsp) frames. The embodiment of the present invention does not limit the format and content of the wake-up password and the transmission mode.

303. The first device detects whether the second device corresponding to the wake-up password exists in a pre-stored list of devices that can wake up the first device. After receiving the wake-up password, the first device may detect whether the second device corresponding to the wake-up password exists in the list of devices that can wake up the first device. The list of devices that can wake up the first device may store second device information and the wake-up password required for the second device to wake up the first device, where the second device information and wake-up password may be added and stored by the first device to the list of devices that can wake up the first device when the second device implements Wi-Fi access through the first device, or may also be preset in the list of devices that can wake up the first device of the first device. The embodiment of the present invention does not limit the process of storing the second device information and wake-up password.

304. If the second device corresponding to the wake-up password exists in the list of devices that can wake up the first device, the first device transmits a first message to the second device, so that the second device switches to a STA mode after receiving the first message, so that the second device implements Wi-Fi through the first device.

When the second device corresponding to the wake-up password exists in the list of devices that can wake up the first device, the first device may transmit the first message to the second device to notify the second device that the first device is woken up successfully, where the first message may be transmitted in a broadcast manner, or may also be transmitted by the first device to the second device in a directed manner. The second device switches to the STA mode after receiving the first message, so that the second device implements Wi-Fi access through the first device. Then the whole wake-up process is completed.

305. The first device disables the Wi-Fi and restarts the timer. When the wake-up password is not detected, the Wi-Fi may be disabled, and the timer may be restarted.

In the method for waking up a device according to the embodiment of the present invention, when a timing interval of a timer is equal to a preset threshold, a first device enters an AP mode, and when the first device detects a wake-up password transmitted by a second device, the first device transmits a first message to the second device, notifying the second device that the first device is woken up. In this case, the second device switches to a STA mode after receiving the first message transmitted by the first device, so that the second device may implement Wi-Fi access through the first device. When the wake-up password of the second device is detected, the first device notifies the second device that the first device is woken up, which improves user experience in a device wake-up process. In addition, when the wake-up password of the second device is not detected, the first device enters a standby mode, which effectively reduces power consumption of the first device and prolongs the standby time and service life of batteries.

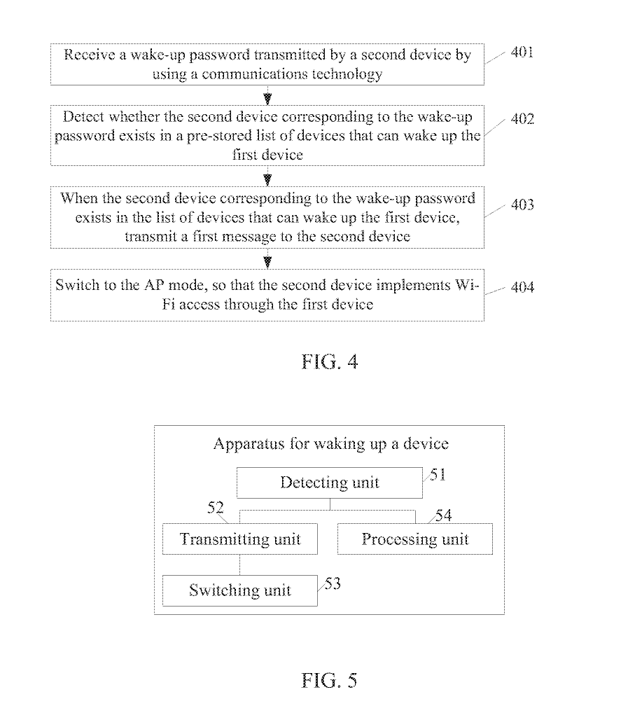

An embodiment of the present invention provides a method for waking up a device. As shown in FIG. 4, the method includes the following steps.

401. A first device receives a wake-up password transmitted by a second device by using a communications technology. The first device may disable Wi-Fi and enter a standby mode when no second device accesses the first device within a period of time. When the second device needs to implement Wi-Fi access through the first device, the second device may transmit a wake-up password to the first device by using the communications technology. The communications technology may be short message service, voice data calling, Bluetooth, and so on.

Note the format and content of the wake-up password are pre-agreed by the first device and second device. The embodiment of the present invention does not limit the format and content of the wake-up password.

402. The first device detects whether the second device corresponding to the wake-up password exists in a pre-stored list of devices that can wake up the first device. When the first device receives the wake-up password transmitted by the second device, the first device may detect whether the second device corresponding to the wake-up password exists in the list of devices that can wake up the first device. The list of devices that can wake up the first device may store second device information and the wake-up password required for the second device to wake up the first device, where the second device information and wake-up password may be added and stored by the first device to the list of devices that can wake up the first device when the second device implements Wi-Fi access through the first device, or may also be preset in the list of devices that can wake up the first device of the first device. The embodiment of the present invention does not limit the process of storing the second device information and wake-up password.

403. When the second device corresponding to the wake-up password exists in the list of devices that can wake up the first device, the first device transmits a first message to the second device. When detecting that the second device corresponding to the wake-up password exists in the list of devices that can wake up the first device, the first device may transmit the first message to the second device to notify the second device that the first device is woken up successfully, where the first message may further include a switching time, used to notify the second device that the first device switches to an AP mode after the switching time. The switching time may also be preset in the second device.

404. The first device switches to the AP mode, so that the second device implements Wi-Fi access through the first device. The first device may switch to the AP mode, so that the second device implements Wi-Fi access through the first device.

In the method for waking up a device according to the embodiment of the present invention, when a first device receives a wake-up password transmitted by a second device by using a communications technology, the first device transmits a first message to the second device, where the first message is used to instruct the second device to switch to a STA mode, and switches itself to an AP mode, so that the second device implements Wi-Fi access through the first device, which improves user experience in a device wake-up process.

An embodiment of the present invention provides an apparatus for waking up a device. As shown in FIG. 5, the apparatus includes a detecting unit 51, a transmitting unit 52, a switching unit 53, and a processing unit 54.

A device that supports Wi-Fi includes a Wi-Fi chip, where the Wi-Fi chip is connected to an antenna by using a radio frequency circuit, and is configured to transmit and receive Wi-Fi signals. In addition, the device includes an application (APP) chip, where the APP chip is configured to run a processor of a Wi-Fi control module, where the Wi-Fi control module is configured to control the Wi-Fi chip. Thereby, the APP chip may control, by using the Wi-Fi control module, the Wi-Fi chip to switch to a STA mode or switch to an AP mode.

The detecting unit 51 is configured to detect, when a timing interval of a timer is equal to a preset threshold, whether a second device transmits a radio signal, where the first device is a device woken up by the second device. The transmitting unit 52 is configured to transmit, when the detecting unit 51 detects the radio signal, a first message to the second device, so that the second device switches to a station STA mode after receiving the first message, where the first message is used to notify the second device that the first device is woken up successfully. The switching unit 53 is configured to switch to an access point AP mode, so that the second device implements wireless fidelity Wi-Fi access through the first device. The processing unit 54 is configured to disable the Wi-Fi when the detecting unit 51 does not detect the radio signal and restart the timer.

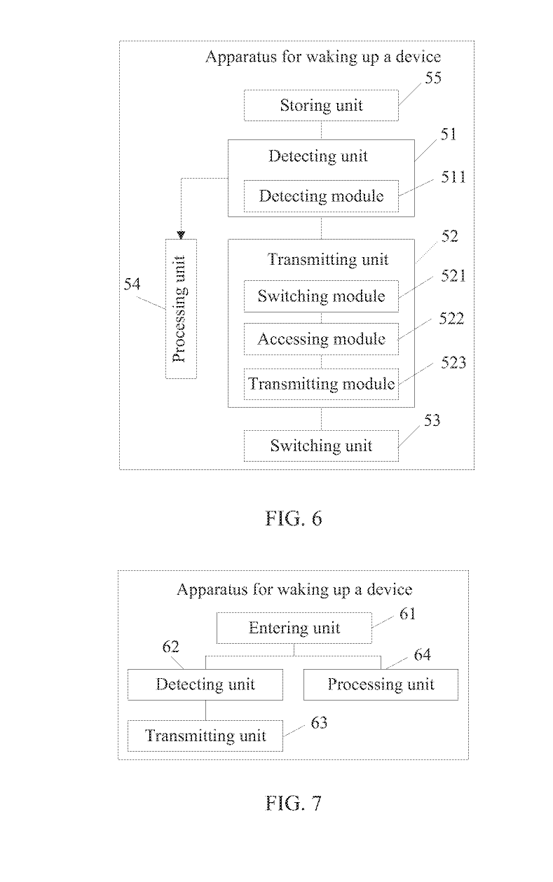

Further, as shown in FIG. 6, the transmitting unit 52 may include a switching module 521, an accessing module 522, and a transmitting module 523. The switching module 521 is configured to switch to the STA mode when the detecting unit 51 detects the radio signal. The accessing module 522 is configured to implement the Wi-Fi access through the second device. The transmitting module 523 is configured to transmit the first message to the second device, where the first message carries a switching time to instruct the second device to switch to the STA mode within the switching time.

Further, the apparatus may include a storing unit 55. The storing unit 55 is configured to store wake-up information of the second device before the detecting unit 51 detects whether the second device transmits the radio signal when the timing interval of the timer is equal to the preset threshold, where the wake-up information includes at least a Wi-Fi network identifier.

The detecting unit 51 may include a detecting module 511. The detecting module 511 is configured to detect, according to the wake-up information stored by the storing unit, whether the second device transmits the radio signal.

In the apparatus for waking up a device according to the embodiment of the present invention, when a timing interval of a timer is equal to a preset threshold and when a first device detects a radio signal transmitted by a second device, the first device transmits a first message to the second device, where the first message is used to instruct the second device to switch to a station STA mode. In this case, the first device is woken up, that is, the first device switches to an AP mode, causing the second device to implement Wi-Fi access through the first device. The first device switches to the AP mode when the radio signal of the second device is detected, which improves user experience in a device wake-up process. In addition, the first device enters a standby mode when the radio signal of the second device is not detected, which effectively reduces power consumption of the first device and prolongs the standby time and service life of batteries.

An embodiment of the present invention provides an apparatus for waking up a device. As shown in FIG. 7, the apparatus includes an entering unit 61, a detecting unit 62, a transmitting unit 63, and a processing unit 64.

A device that supports Wi-Fi includes a Wi-Fi chip, where the Wi-Fi chip is connected to an antenna by using a radio frequency circuit, and is configured to transmit and receive Wi-Fi signals. In addition, the device includes an application (Application, APP) chip, where the APP chip is configured to run a processor of a Wi-Fi control module, where the Wi-Fi control module is configured to control the Wi-Fi chip. Thereby, the APP chip may control, by using the Wi-Fi control module, the Wi-Fi chip to switch to a STA mode or switch to an AP mode.

The entering unit 61 is configured to enter the AP mode when a timing interval of a timer is equal to a preset threshold, where the first device is a device woken up by a second device. The detecting unit 62 is configured to detect whether a wake-up password transmitted by the second device is received. The transmitting unit 63 is configured to transmit a first message to the second device when the detecting unit 62 detects the wake-up password, so that the second device switches to the STA mode after receiving the first message, and the second device implements wireless fidelity Wi-Fi access through the first device, where the first message is used to notify the second device that the first device is woken up successfully. The processing unit 64 is configured to disable the Wi-Fi when the detecting unit 62 does not detect the wake-up password and restart the timer.

Further, as shown in FIG. 8, the transmitting unit 63 may include a detecting module 631 and a transmitting module 632. The detecting module 631 is configured to detect, when the detecting unit 62 detects the wake-up password, whether the second device corresponding to the wake-up password exists in a pre-stored list of devices that can wake up the first device. The transmitting module 632 is configured to transmit the first message to the second device when the detecting module 631 detects that the second device corresponding to the wake-up password exists in the pre-stored list of devices that can wake up the first device.

In the apparatus for waking up a device according to the embodiment of the present invention, when a timing interval of a timer is equal to a preset threshold, a first device enters an AP mode, and when the first device detects a wake-up password transmitted by a second device, the first device transmits a first message to the second device, notifying the second device that the first device is woken up. In this case, the second device switches to a STA mode after receiving a wake-up complete message transmitted by the first device, causing the second device to implement Wi-Fi access through the first device. When the wake-up password of the second device is detected, the first device notifies the second device that the first device is woken up, which improves user experience in a device wake-up process. In addition, when the wake-up password of the second device is not detected, the first device enters a standby mode, which effectively reduces power consumption of the first device and prolongs the standby time and service life of batteries.

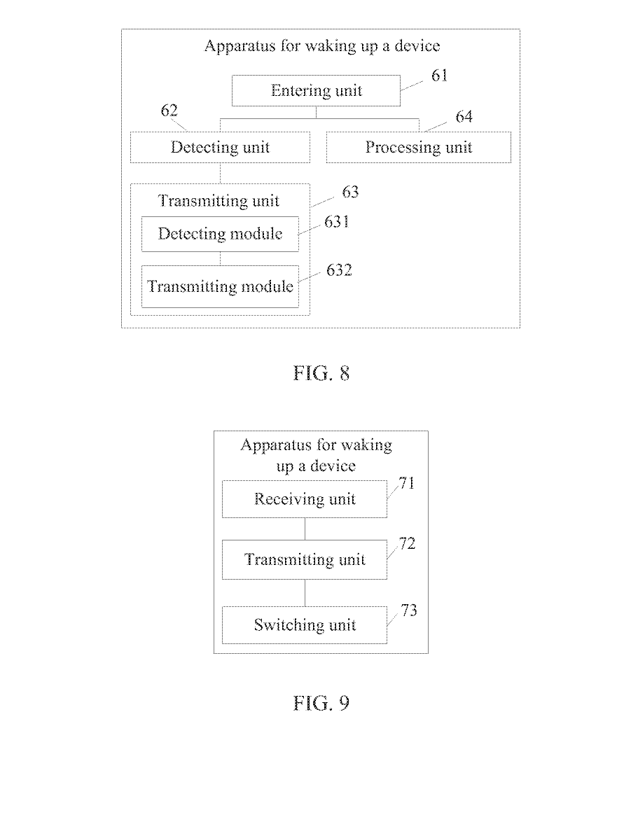

An embodiment of the present invention provides an apparatus for waking up a device. As shown in FIG. 9, the apparatus includes a receiving unit 71, a transmitting unit 72, and a switching unit 73.

A device that supports Wi-Fi includes a Wi-Fi chip, where the Wi-Fi chip is connected to an antenna by using a radio frequency circuit, and is configured to transmit and receive Wi-Fi signals. In addition, the device includes an application (Application, APP) chip, where the APP chip is configured to run a processor of a Wi-Fi control module, where the Wi-Fi control module is configured to control the Wi-Fi chip. Thereby, the APP chip may control, by using the Wi-Fi control module, the Wi-Fi chip to switch to a STA mode or switch to an AP mode.

The receiving unit 71 is configured to receive a wake-up password transmitted by a second device by using a communications technology, where the first device is a device woken up by the second device. The transmitting unit 72 is configured to transmit a first message to the second device, so that the second device switches to the STA mode after receiving the first message, where the first message is used to notify the second device that the first device is woken up successfully. The switching unit 73 is configured to switch to the AP mode, so that the second device implements wireless fidelity Wi-Fi access through the first device.

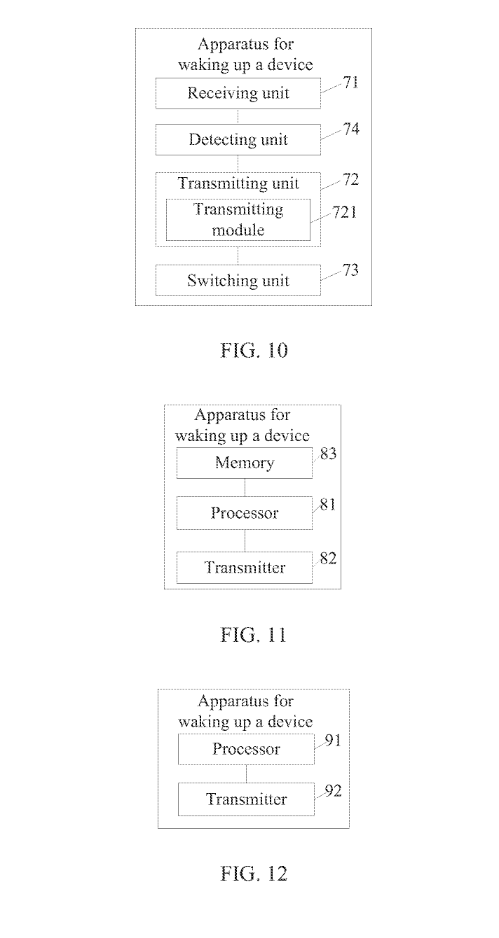

Further, as shown in FIG. 10, the apparatus may include a detecting unit 74. The detecting unit 74 is configured to detect, after the receiving unit 71 receives the wake-up password transmitted by the second device by using the communications technology, whether the second device corresponding to the wake-up password exists in a pre-stored list of devices that can wake up the first device.

Further, the second unit 72 may include a transmitting module 721. The transmitting module 721 is configured to transmit the first message to the second device when the detecting unit 74 detects that the second device corresponding to the wake-up password exists in the pre-stored list of devices that can wake up the first device.

In the apparatus for waking up a device according to the embodiment of the present invention, when a first device receives a wake-up password transmitted by a second device by using a communications technology, the first device transmits a first message to the second device, where the first message is used to instruct the second device to switch to a STA mode, and switches itself to an AP mode, causing the second device to implement Wi-Fi access through the first device, which improves user experience in a device wake-up process, effectively reduces power consumption of the first device, and prolongs the standby time and service life of batteries.

An embodiment of the present invention provides an apparatus for waking up a device. As shown in FIG. 11, the apparatus includes a processor 81 and a transmitter 82. The processor 81 is configured to detect, when a timing interval of a timer is equal to a preset threshold, whether a second device transmits a radio signal, where the first device is a device woken up by the second device. The transmitter 82 is configured to transmit a first message to the second device when the processor 81 detects the radio signal, so that the second device switches to a station STA mode after receiving the first message, where the first message is used to notify the second device that the first device is woken up successfully. The processor 81 is further configured to switch to an access point AP mode, so that the second device implements wireless fidelity Wi-Fi access through the first device. The processor 81 is further configured to disable the Wi-Fi when the radio signal is not detected and restart the timer. Further, the processor 81 is configured to switch to the STA mode when the radio signal is detected, and implement the Wi-Fi access through the second device. The transmitter 82 is further configured to transmit the first message to the second device, where the first message carries a switching time to instruct the second device to switch to the STA mode within the switching time.

Further, the apparatus includes a memory 83. The memory 83 is configured to store wake-up information of the second device before the processor 81 detects whether the second device transmits the radio signal when the timing interval of the timer is equal to the preset threshold, where the wake-up information includes at least a Wi-Fi network identifier. The processor 81 is further configured to detect, according to the wake-up information stored by the memory 83, whether the second device transmits the radio signal.

In the apparatus for waking up a device according to the embodiment of the present invention, when a timing interval of a timer is equal to a preset threshold and when a first device detects a radio signal transmitted by a second device, the first device transmits a first message to the second device, where the first message is used to instruct the second device to switch to a STA mode. In this case, the first device is woken up, that is, the first device switches to an AP mode, so that the second device may implement Wi-Fi access through the first device. The first device switches to the AP mode when the radio signal of the second device is detected, which improves user experience in a device wake-up process. In addition, the first device enters a standby mode when the radio signal of the second device is not detected, which effectively reduces power consumption of the first device and prolongs the standby time and service life of batteries.

An embodiment of the present invention provides an apparatus for waking up a device. As shown in FIG. 12, the apparatus includes a processor 91 and a transmitter 92. The processor 91 is configured to switch to an AP mode when a timing interval of a timer is equal to a preset threshold, and detect whether a wake-up password transmitted by a second device is received, where the first device is a device woken up by the second device. The transmitter 92 is configured to transmit a first message to the second device when the processor 91 detects the wake-up password, causing the second device to switch to a STA mode after receiving the first message, and causing the second device to implement Wi-Fi access through the first device, where the first message is used to notify the second device that the first device is woken up successfully. The processor 91 is further configured to disable the Wi-Fi when the wake-up password is not detected and restart the timer. Further, the processor 91 is configured to detect, when the wake-up password is detected, whether the second device corresponding to the wake-up password exists in a pre-stored list of devices that can wake up the first device. The transmitter 92 is further configured to transmit the first message to the second device when it is detected that the second device corresponding to the wake-up password exists in the list of devices that can wake up the first device.

In the apparatus for waking up a device according to the embodiment of the present invention, when a timing interval of a timer is equal to a preset threshold, a first device enters an AP mode, and when the first device detects a wake-up password transmitted by a second device, the first device transmits a first message to the second device, notifying the second device that the first device is woken up. In this case, the second device switches to a STA mode after receiving a wake-up complete message transmitted by the first device, causing the second device to implement Wi-Fi access through the first device. When the wake-up password of the second device is detected, the first device notifies the second device that the first device is woken up, which improves user experience in a device wake-up process. In addition, when the wake-up password of the second device is not detected, the first device enters a standby mode, which effectively reduces power consumption of the first device and prolongs the standby time and service life of batteries.

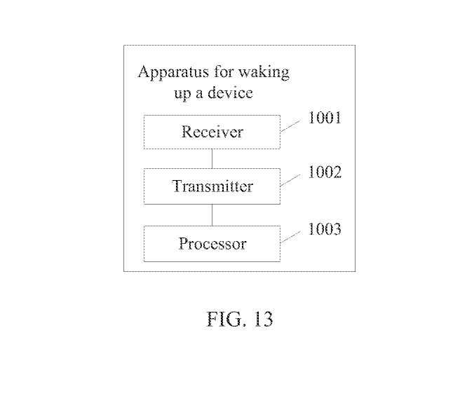

An embodiment of the present invention provides an apparatus for waking up a device. As shown in FIG. 13, the apparatus includes a receiver 1001, a transmitter 1002, and a processor 1003. The receiver 1001 is configured to receive a wake-up password transmitted by a second device by using a communications technology, where the first device is a device woken up by the second device. The transmitter 1002 is configured to transmit a first message to the second device, so that the second device switches to a station STA mode after receiving the first message, where the first message is used to notify the second device that the first device is woken up successfully. The processor 1003 is configured to switch to an access point AP mode, so that the second device implements wireless fidelity Wi-Fi access through the first device.

Further, the processor 1003 is configured to detect, after the receiver 1001 receives the wake-up password transmitted by the second device by using the communications technology, whether the second device corresponding to the wake-up password exists in a pre-stored list of devices that can wake up the first device. Further, the transmitter 1002 is configured to transmit the first message to the second device when the processor 1003 detects that the second device corresponding to the wake-up password exists in the list of devices that can wake up the first device.

In the apparatus for waking up a device according to the embodiment of the present invention, when a first device receives a wake-up password transmitted by a second device by using a communications technology, the first device transmits a first message to the second device, where the first message is used to instruct the second device to switch to a STA mode, and switches itself to an AP mode, causing the second device to implement Wi-Fi access through the first device, which improves user experience in a device wake-up process, effectively reduces power consumption of the first device, and prolongs the standby time and service life of batteries.

Through the foregoing description of the embodiments, it is clear to a person skilled in the art that the present invention may be implemented by software in addition to necessary universal hardware, and definitely may also be implemented by hardware, but in many cases, the software implementation is preferred. Based on such understanding, the technical solutions of the present invention essentially, or the parts contributing to the prior art may be implemented in the form of a software product. The computer software product is stored in a readable storage medium, for example, a floppy disk, a hard disk, or an optical disc in a computer, and includes several instructions for instructing a computer device (which may be a personal computer, a server, a network device, and the like) to execute the methods described in the embodiments of the present invention.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for waking up a device, comprising:
detecting, by a first device when a timing interval of a timer is equal to a preset threshold, whether a second device transmits a radio signal wherein the first device is woken up by the second device;
transmitting, by the first device when the radio signal is detected, a first message to the second device, causing the second device to switch to a station (STA) mode after receiving the first message, wherein the first message is used to notify the second device that the first device was woken up successfully;
switching, by the first device, to an access point (AP) mode, causing the second device to implement wireless fidelity (Wi-Fi) access through the first device; and
disabling, by the first device, the Wi-Fi and restarting the timer when the radio signal is not detected.

2. The method according to claim 1, wherein the transmitting, by the first device, the first message to the second device, comprises:
switching, by the first device, to the STA mode when the radio signal is detected;
implementing, by the first device, the Wi-Fi access through the second device; and
transmitting, by the first device, the first message to the second device, wherein the first message carries a switching time to instruct the second device to switch to the STA mode within the switching time.

3. The method according to claim 2, wherein before the detecting, by the first device, whether the second device transmits a radio signal, and when a timing interval of a timer is equal to a preset threshold, the method further comprises:
storing, by the first device, wake-up information of the second device, wherein the wake-up information comprises at least a Wi-Fi network identifier; and
the detecting whether the second device transmits the radio signal specifically comprises: detecting, by the first device according to the wake-up information, whether the second device transmits the radio signal.

4. The method according to claim 1, wherein before the detecting, by the first device, whether the second device transmits a radio signal, and when a timing interval of a timer is equal to a preset threshold, the method further comprises:
storing, by the first device, wake-up information of the second device, wherein the wake-up information comprises at least a Wi-Fi network identifier; and
the detecting whether the second device transmits the radio signal further comprises: detecting, by the first device according to the wake-up information, whether the second device transmits the radio signal.

5. A method for waking up a device, comprising:
entering, by a first device, an access point (AP) mode when a timing interval of a timer is equal to a preset threshold, wherein the first device is woken up by a second device;
detecting, by the first device, whether a wake-up password transmitted by the second device is received;
transmitting, by the first device, a first message to the second device when the wake-up password is detected, causing the second device to switch to a station (STA) mode after receiving the first message, and implementing, by the second device, wireless fidelity (Wi-Fi) access through the first device, wherein the first message is used to notify the second device that the first device is woken up successfully; and
disabling, by the first device, the Wi-Fi and restarting the timer when the wake-up password is not detected.

6. The method according to claim 5, wherein the transmitting, by the first device when the wake-up password is detected, the first message to the second device, comprises:
detecting, by the first device, whether the second device corresponding to the wake-up password exists in a pre-stored list of devices that can wake up the first device, when the wake-up password is detected; and
performing the transmitting of the first message to the second device when the second device corresponding to the wake-up password exists in the pre-stored list of devices that can wake up the first device.

7. A method for waking up a device, comprising:
receiving, by a first device, a wake-up password transmitted by a second device by using a communications technology, wherein the first device is woken up by the second device;
transmitting, by the first device, a first message to the second device, causing the second device to switch to a station (STA) mode after receiving the first message, wherein the first message is used to notify the second device that the first device is woken up successfully; and
switching, by the first device, to an access point (AP) mode, causing the second device to implement wireless fidelity (Wi-Fi) access through the first device.

8. The method according to claim 7, wherein after the receiving, by the first device, the wake-up password transmitted by the second device by using the communications technology, the method further comprises detecting whether the second device corresponding to the wake-up password exists in a pre-stored list of devices that can wake up the first device.

9. The method according to claim 8, wherein the transmitting, by the first device, the first message to the second device, comprises transmitting, by the first device, the first message to the second device when the second device corresponding to the wake-up password exists in the pre-stored list of devices that can wake up the first device.

10. An apparatus for waking up a device, comprising:
a processor configured to detect whether a second device transmits a radio signal, when a timing interval of a timer is equal to a preset threshold, where a first device is woken up by the second device, and to switch to an access point AP mode, causing the second device to implement wireless fidelity Wi-Fi access through the first device; and
a transmitter coupled to the processor and configured to transmit a first message to the second device when the processor detects the radio signal, causing the second device to switch to a station (STA) mode after receiving the first message, where the first message is used to notify the second device that the first device is woken up successfully.

11. The apparatus according to claim 10,
wherein the processor is further configured to switch to the STA mode when the radio signal is detected, and implement the Wi-Fi access through the second device; and
the transmitter is further configured to transmit the first message to the second device, where the first message carries a switching time to instruct the second device to switch to the STA mode within the switching time.

12. The apparatus according to claim 11, further comprising:
a memory coupled to the processor and configured to store wake-up information of the second device before the processor detects whether the second device transmits the radio signal when the timing interval of the timer is equal to the preset threshold, where the wake-up information includes at least a Wi-Fi network identifier; and
the processor is further configured to detect whether the second device transmits the radio signal according to the wake-up information stored by the memory.

13. The apparatus according to claim 10, further comprising:
a memory configured to store wake-up information of the second device before the processor detects whether the second device transmits the radio signal when the timing interval of the timer is equal to the preset threshold, where the wake-up information includes at least a Wi-Fi network identifier; and
the processor is further configured to detect whether the second device transmits the radio signal according to the wake-up information stored by the memory.

14. An apparatus for waking up a device, comprising:
a processor configured to switch to an access point (AP) mode when a timing interval of a timer is equal to a preset threshold, and detect whether a wake-up password transmitted by a second device is received, where a first device is woken up by the second device; and
a transmitter coupled to the processor and configured to transmit a first message to the second device when the processor detects the wake-up password, causing the second device to switch to a station (STA) mode after receiving the first message, and causing the second device to implement wireless fidelity (Wi-Fi) access through the first device, where the first message is used to notify the second device that the first device is woken up successfully.

15. The apparatus according to claim 14,
wherein the processor is further configured to detect whether the second device corresponding to the wake-up password exists in a pre-stored list of devices that can wake up the first device, when the wake-up password is detected; and
the transmitter is further configured to transmit the first message to the second device when it is detected that the second device corresponding to the wake-up password exists in the list of devices that can wake up the first device.

16. An apparatus for waking up a device, comprising:
a receiver configured to receive a wake-up password transmitted by a second device by using a communications technology, where a first device is woken up by the second device;
a transmitter configured to transmit a first message to the second device, causing the second device to switch to a station (STA) mode after receiving the first message, where the first message is used to notify the second device that the first device is woken up successfully; and
a processor coupled to the receiver and the transmitter, and configured to switch to an access point (AP) mode, causing the second device to implement wireless fidelity (Wi-Fi) access through the first device.

17. The apparatus according to claim 16, wherein the processor is further configured to detect, after the receiver receives the wake-up password transmitted by the second device by using the communications technology, whether the second device corresponding to the wake-up password exists in a pre-stored list of devices that can wake up the first device.

18. The apparatus according to claim 17, wherein the transmitter is further configured to transmit the first message to the second device when the processor detects that the second device corresponding to the wake-up password exists in the list of devices that can wake up the first device.
